(19) United States
(12) Patent Application Publication
(10) Pub. No.: US 2020/0399883 A1
(43) Pub. Date: Dec. 24, 2020

(54) Surface Drain Precursor Screen

(71) Applicant: Safe Drain Stormwater Holdings, Inc., Oakdale, CA (US)

(72) Inventor: John P. Deming, Ripon, CA (US)

(73) Assignee: Safe Drain Stormwater Holdings, Inc., Oakdale, CA (US)

(21) Appl. No.: 16/995,823

(22) Filed: Aug. 18, 2020

Related U.S. Application Data
(60) Provisional application No. 62/862,685, filed on Jun. 18, 2019.

(51) Int. Cl. E03F 5/14; C02F 1/00; B01D 29/50; B01D 39/10

(52) U.S. Cl. CPC E03F 5/14; C02F 1/004; C02F 2103/001; B01D 39/10; B01D 29/50

(57) ABSTRACT

A storm drain precursor screen comprising a perforated tray with a frame configured to capture and remove debris and trash from stormwater runoff that occurs during a wet weather event. The storm drain precursor screen is configured to fit within the physical geometry of each storm drain intake. Where a shoulder is not provided in a storm drain collection box, additional supports may be bolted or anchored into the walls of the collection box to support the precursor screen.

### STATEMENT REGARDING FEDERALLY SPONSORED RESEARCH OR DEVELOPMENT

This application claims the benefit of U.S. Provisional Application No. 62/862,685 filed Jun. 18, 2019.

### CROSS-REFERENCE TO RELATED APPLICATIONS

None

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD

The inventive subject matter described herein is related to devices to enhance the functionality of surface drain systems, including storm drains.

### BACKGROUND

Stormwater is defined by the US Environmental Protection Agency (EPA) as the runoff generated when precipitation from rain and snowmelt events flows over land or impervious surfaces without percolating into the ground. As it flows, stormwater runoff collects and transports pollutants to surface waters. Some of these pollutants are visible such as sediment, motor oil, trash, and debris. Other pollutants are not easily visible such as dissolved metals, nutrients, oxygen-demanding substances, and organic chemicals. Although the number and amount of pollutants from a single residential, commercial, industrial or construction site may seem unimportant, the combined concentrations of contaminants threaten lakes, rivers, wetlands and other water bodies. Pollution conveyed by stormwater degrades the quality of drinking water, damages fisheries and habitat of plants and animals that depend on clean water for survival. Pollutants carried by stormwater can also affect recreational uses of water bodies by making them unsafe for wading, swimming, boating, and fishing. In most cases, stormwater flows directly to water bodies through separate storm sewer systems, contributing a major source of pollution to rivers, lakes, and the ocean.

The Federal Clean Water Act (Clean Water Act) prohibits certain discharges of stormwater containing pollutants except in compliance with a National Pollutant Discharge Elimination System (NPDES) permit. The NPDES stormwater program regulates some stormwater discharges from three potential sources: municipal separate storm sewer systems (MS4s), construction activities, and industrial activities.

An original purpose of storm drains was to prevent flooding of streets by quickly transferring rainwater to natural bodies of water. Consequently, the majority of storm drain intakes receiving runoff from storm events lead to our watersheds, streams, rivers, lakes, and oceans. Consequently, the pollutants, debris, and trash picked up by the runoff will enter the storm drainage systems and foul our natural waterways if not intercepted in some manner.

For example, even on a dry day, according to the Los Angeles Times, tens of millions of gallons of dirty water dumps into the Pacific Ocean through the Los Angeles region's vast storm drain system. The 3,500-mile storm drain network was designed and built to empty streets of rainwater, but tons of litter also flow into the Pacific Ocean through the intricate system of curbside drains, underground channels, pumps, and creeks. The stormwater pollution puts beach swimmers at risk, particularly after it rains. Marine animals and plants can also get sick or die. The curbside drains collect rainwater, along with pet waste, human waste, fertilizers, plastic, paper, other litter, rubber granules, sediment, motor oil, and other dissolved contaminants. In Los Angeles County alone, there are approximately 160,000 catch basins. Unlike sewage, the stormwater collected in these catch basins is not treated and cleaned before discharge.

Today, surface water run-off is coming under increased scrutiny as a primary source of pollutants entering groundwater, streams, and rivers. As water from rain or snowmelt and other sources flow over the surface of the ground it picks up a wide variety of pollutants, ranging from large and small debris, suspended solids and sediment to oils and other soluble and insoluble chemical contaminants. Because surface water is relatively easily contained through storm sewers and dry wells, many agencies at all levels of the government are paying increased attention to both the contaminants that enter the water system through surface water run-off, and to methods to control and eliminate such contaminants. Moreover, governmental regulations currently in place put restrictions on the amount of sediment that can be permitted to flow into sewer systems.

The municipal storm sewer system, also known as a stormwater system or a storm drain network, is one type of traditional surface water conveyance system. For the remainder of this disclosure, we will refer to such systems as stormwater systems, storm drain systems, and conveyance systems, to distinguish from a “sanitary sewer system” that deals with the movement of sewage to treatment facilities. A stormwater conveyance system is composed of storm drains, catch basins, vaults, drains and piping connecting the vaults, catch basins and drains to an ultimate outlet, e.g., an outfall, or a repository, e.g., a retention pond. In certain communities, both the sanitary sewer system and the stormwater conveyance system use the same piping to convey both stormwater and sewage from one location to another. In some cases, the convergence of the sanitary sewer flows and stormwater flows into the same conveyance network is caused by an unusually extreme wet weather event. This typically further results in a release of sanitary sewer flow at beaches and bays, creating extremely toxic and unhealthy conditions for humans, fish and animals alike.

A typical stormwater system will comprise a network of grated storm drains, catch basins and vaults that are interconnected with concrete sewer pipe. Surface water, typically stormwater runoff, flows across impervious surfaces via gravity to a storm drain site and through a storm drain grate. The storm drain grate catches larger objects such as branches, rocks and the like. The runoff that flows through the grate typically enters a vault portion of the catch basin where some nonfloatable debris and sediment may settle to the bottom. However, in other situations, the catch basin may include an insert basin that serves multiple purposes. For example, in one instance, the insert basin my act as a solid, nonpermeable barrier with a valve that prevents contaminants from entering the stormwater system unless the valve is opened. In other instances, the insert may act as a perforated capture basin that collects and removes trash from the runoff. The remaining runoff and floatable debris may be carried into the stormwater conveyance network. Depending upon the design of the overall network, the runoff may be directed to a processing/pretreatment facility, detention pond, aeration pond, a bioswale, a groundwater recharge facility, a different catch basin or directly into a stream, river or other water body via an outfall.

A traditional stormwater system comprised of collection points and lateral piping is useful as a primary, but inflexible, stormwater conveyance system. For example, a catch basin and lateral lines can quickly be impaired and obstructed if the runoff contains a high level of solids, sediment, or debris. Additionally, this obstructive sediment and debris may scrubbed out by other wet weather events to end up in creeks, lakes, bays, estuaries and the ocean, causing significant detrimental pollution of these water bodies.

Catch basins and inlets are manufactured in a wide variety of shapes and sizes. They are typically made from concrete and may be cylindrical, box-shaped, combinations thereof or other shapes as necessary to the system installation and required volumetric capacity. A catch basin typically sits below grade level, making the effort of cleaning sediment or debris out of the basin a difficult and expensive undertaking, requiring specialized equipment, such as a specialized sewer and catch basin vacuum truck system. Cleaning is more difficult if the system is clogged (catch basins and lateral lines) and/or the catch basin is underwater due to clogging. Expensive jetting systems are required to clean out lateral lines.

Municipalities have begun to impose fees on catch basin users, whether the catch basin is connected to a storm sewer system or a dry well. While these fees apply in most instances to commercial users, they can also apply to residential systems and highway systems. In large part, the fees are based on the kind and amount of pollutants that flow through a catch basin and into the associated conveyance or distribution system. The higher the level of contaminants flowing through the system, the higher the fee.

Additionally, fees can be driven by the type of contaminant. For example, oils flowing into a catch basin, dry well or other treatment facility can lead to increased fees due to toxicity and difficulty in removal. These fees can apply to private as well as public dry well users since it is in the interest of a municipality to control the pollution that enters the groundwater from both private and public sources.

There exists a continuing and significant need to prevent contaminants from flowing into stormwater conveyance systems and associated water resources. First, decreasing contamination of all kinds from surface water runoff causes the water that flows back into the ground and into streams and rivers to be cleaner. Second, fees paid by operators of stormwater systems and dry wells may be reduced by the removal and reduction of contaminants that flow into their systems. Further, the costs associated with cleaning catch basins or reconditioning dry wells are substantial, therefore, minimizing contaminants that would impair these systems is financially beneficial.

Debris in stormwater runoff can accumulate and create obstructions in irregularities of the drainage system. Larger objects that first become obstructed in the system collect other smaller objects that cannot pass through and the smaller objects then obstruct yet other smaller objects, and so on until the system becomes completely clogged. If the flow of stormwater runoff through any part of the drainage system becomes obstructed, the flow rate is reduced, thereby placing additional constraints on other parts of the drainage system. If the blockage or obstruction of the drainage system is not eventually alleviated, flooding and unsafe conditions can result. Cities and highway departments employ maintenance crews for maintaining the storm drain systems. Governmental regulations impose requirements for storm drain systems. For example, in new construction, the developer is required to place barriers to prevent runoff into storm drains.

Given the interest in removing debris and contaminants from surface water run-off, various catch basin and debris removal designs have been devised. As early as 1871, in U.S. Pat. No. 122,209 by Ashman et al, an iron grate is installed down within in a catch basin for removing sticks and other large-sized articles. The grate is consistent with the design of a surface storm drain grate. As can be appreciated, due to the wide spacing between the bars of the iron grate, such a system cannot remove debris smaller than the spacing between the bars. Hence, the disclosure of Ashman et al does not provide a precursor filtration stage to improve performance of subsequent filtration stages.

Jumping from 1871 to 1992, in U.S. Pat. No. 5,133,619 to Murfae et al, “Storm Water Filtration System for Use with Conventional Storm Water Collection Sewers,” a water filtration system is disclosed which is connected in series with a conventional storm drain system. The filtration system includes a filter basin with a charcoal filter, and a filter basket insertable into the basin. The basket is filled with sand or other fine material. When the filter basket becomes full, a hinged door closes and drainage water is diverted and proceeds down a gutter to the conventional storm drain inlet where it is carried to the underground system. The water filtration system of Murfae et al can be used only in new construction areas. It is not retrofittable into a conventional storm drain system without substantial cost. Such a filtration system does not efficiently utilize space, as it is installed upstream from a conventional storm drain system. Also, costly motorized forklift equipment is required to remove the filter basket and the collected debris and recharge it with new filter material. Further, the disclosure of Murfae et al does not provide a means to create a precursor filtration stage to improve subsequent filtration stages.

Granted in 1994, U.S. Pat. No. 5,284,580 to Shyh-Yuan Shyh, a “Refuse Collecting Frame for Sewer,” describes a preferably rectangular or cubic frame designed to collect trash within a drainage sewer. The disclosure of Shyh describes a basin that fits into the sewer drain and is removable. The basin has a filtering net for trapping debris that flows into the basin through a sewer cover or grate. The imperforate collection basin catches particulate matter while tiny particles flow through the system with the run-off water. However, the configuration does not allow the invention of Shyh to serve as an effective precursor to additional filtration stages.

Yet another filtration apparatus is disclosed by George E. Logue, Jr. in U.S. Pat. No. 5,372,714, “Storm Sewer Catch Basin and Filter,” granted in 1994. The disclosure of Logue describes a filter adapted for use with below grade catch basins comprising a porous woven plastic fabric bag. The filter bag hangs into the catch basin, supported by the overlying storm drain grate. When full, the bag is removed by inserting lifting rods into loops of fabric connected to the bag. However, the configuration of Logue does not serve as an effective precursor to additional filtration stages.

Another example of a surface water filtration apparatus is disclosed by Thomas W. Schneider in U.S. Pat. No. 5,405,539, “Storm Drain Filter System,” granted in 1995. The disclosure of Schneider describes a complex, multi-part insert basin that supports a sheet of filter medium, such as a woven synthetic material. Pneumatic rams hold the frame in place in the catch basin. Silt and other particulate debris collect on the filter compartment until the woven filter is clogged and/or the filter compartment is full, at which time excess drainage water overflows, unfiltered, over the back of the filter drain and into the storm sewer system. The woven filter is replaced by removing the spent sheet from the catch basin and replacing it with fresh material. The disclosure fails to address flexibility in filter media and an ability to interrupt flow through the filtration device for service or repair. In addition, the configuration does not allow the invention of Schneider to serve as an effective precursor to additional filtration stages.

From the foregoing, it can be seen that a need exists for an initial filtration stage that serves as a precursor to improve the performance of subsequent filtration stages. Another need exists for a storm drain filtration system that can serve as a precursor filtration solution to first remove gross debris and trash to improve the operation and functionality of a subsequent filtration or treatment stages. Another need exists for a solution that will improve the capture of trash and debris, yet achieve a high flow rate to accommodate a substantial volume of stormwater runoff during a wet weather event. These and other needs are fulfilled by the precursor screen according to the inventive subject matter as described in more detail below.

### SUMMARY

In view of the foregoing described needs, an aspect of the inventive subject matter is directed to a novel implementation of a precursor screen for deployment within existing storm drain collection basins having existing capture devices or not. The precursor screen is appropriate for inclusion in new precast and other types of storm drain catchments, catch basins, vaults and collection boxes. The inventive subject matter provides an optimized precursor screen to supplement other devices that might be used in a collection box and is installed with an overlying grate of an existing storm drain, within the opening of a sidewalk drain positioned adjacent a curb and in association with other types of storm drain collection points including area drains. The inventive subject matter may be adapted to fit and operate within a plurality of different storm drain collection points, both large and small. The precursor screen is preferably shaped to fit the mouth of a collection box. In many cases, the precursor screen will be rectangular-shaped comprising a tray fabricated from perforated stainless steel material. The precursor screen includes a perforated tray and support frame. The perforated tray includes a U-shaped base screen and two end screens. The base screen and two end screens may have equivalent perforation size, density, distribution, and spacing. Each end screen includes U-shaped lips that create a channel in which an end of the base screen is placed for assembly. During assembly, the end screens can be easily adjusted such that a plurality of perforations in the lips are aligned with perforations in the base screen. Rivets are passed through aligned perforations to fasten the end screens to the base screen. The assembled tray is attached to a metal support frame that fits within and conforms to the interior of the tray. A vertical leg of the metal frame fits within the opening of the tray. Multiple holes are linearly spaced along the length of the vertical leg of the frame. The holes are equivalent in size to the perforations and are spaced consistently with the spacing of the perforations in the base screen and end screens of the perforated tray. The tray is fastened to the vertical leg of the frame along its length in one case using rivets. The vertical leg of the frame may further include one or more weep holes in the face of the vertical leg to allow overflow into the collection basin if the entire tray should become filled and clogged. The weep holes may be larger in size than the perforations. The frame further includes a flange that circumscribes the frame and serves as a means for supporting the precursor screen within the mouth of the collection box. Thusly configured, the inventive subject matter can be inexpensively manufactured and simply and easily installed and serviced. In another configuration, the base screen may be raised to cover the weep holes to minimize overflow, still using the same perforation arrangement.

The inventive subject matter described herein comprises a storm drain precursor screen comprising a perforated tray, the perforated tray joined to a support frame having a perimeter support flange configured to rest on a perimeter support in a collection box. The perforated tray is joined with the support frame via rivets. The perforated tray comprises a base screen; a first end screen; and, a second end screen. The support frame comprises two end pieces and two side pieces joined via a welded seam to form a frame. The support frame is then joined to the perforated tray via rivets.

The support frame includes a plurality of rivet holes distributed about a perimeter leg of the support frame. The rivet holes are spaced and aligned to correlate with perforations in the perforated tray for assembly using a plurality of rivets. In one instance, the perforations are less than 5 mm in size to prevent particles 5 mm or larger from passing through the perforations. In another instance, the perforations are no larger than 1 mm when dealing with preventing the passage of plastic particles. The vertical leg of the support frame may also include one or more weep holes.

The storm drain precursor screen further includes the perforated tray having a first perforated end screen with a first U-shaped lip and a second perforated end screen with a second U-shaped lip for receiving and securing a first end of the base screen and a second end of the base screen using a plurality of rivets to form the perforated tray.

Still further, the precursor screen is preferably made in its entirety from stainless steel. In one instance, the perforated tray is manufactured from a single sheet of stainless steel stock. In another instance, the support frame is manufactured from a single sheet of stainless steel stock.

These and other features of the inventive subject matter will be more readily understood upon consideration of the attached drawings and of the following detailed description of those drawings and the presently-preferred and other embodiments of the inventive subject matter.

### BRIEF DESCRIPTION OF THE SEVERAL VIEWS OF THE DRAWING

For a better understanding of the inventive subject matter, reference is made to the detailed description contained herein and the accompanying drawing figures numbered below which are given by way of illustration only and are not intended to be limiting to any extent. Commonly used reference numbers identify the same or equivalent parts of the claimed invention throughout the several figures. These and other features, aspects and advantages of various embodiments of the inventive subject matter will become better understood with regard to the following description, appended claims, and accompanying drawings where:

FIG. 1 is a perspective view of the precursor screen, according to the inventive subject matter;

FIG. 2 is an exploded view of the precursor screen of FIG. 1;

FIG. 3A is a top plan view of the precursor screen of FIG. 1;

FIG. 3 B is a side elevation view of the precursor screen of FIG. 1;

FIG. 3C is a bottom plan view of the precursor screen of FIG. 1;

FIG. 4A is a view of the installed precursor screen according to the inventive subject matter with the valve closed; FIG. 4B is an enlarged view of the precursor screen in FIG. 4A.

FIG. 5 is a side cross-sectional view of the precursor screen installed above a valved filtration apparatus, according to the inventive subject matter; and,

FIG. 6A is a view of the installed precursor screen according to the inventive subject matter with the valve open; FIG. 6B is an enlarged view of the precursor screen in FIG. 6A.

### DETAILED DESCRIPTION

The following description is merely exemplary in nature and is in no way intended to limit the invention, the inventive subject matter, its application, or its uses. Before the inventive subject matter is described in further detail, it is to be understood that the invention is not limited to the particular aspects described, as such may, of course, vary. It is also to be understood that the terminology used herein is for describing particular aspects only, and is not intended to be limiting since the scope of the present invention will be limited only by the appended claims.

Unless defined otherwise, all technical and scientific terms used herein have the same meaning as commonly understood by one of ordinary skill in the art to which this inventive subject matter belongs. Although any methods and materials similar or equivalent to those described herein can also be used in the practice or testing of the inventive subject matter, a limited number of the exemplary methods and materials are described herein.

It must be noted that as used herein and in the appended claims, the singular forms “a”, “an”, and “the” include plural referents unless the context clearly dictates otherwise.

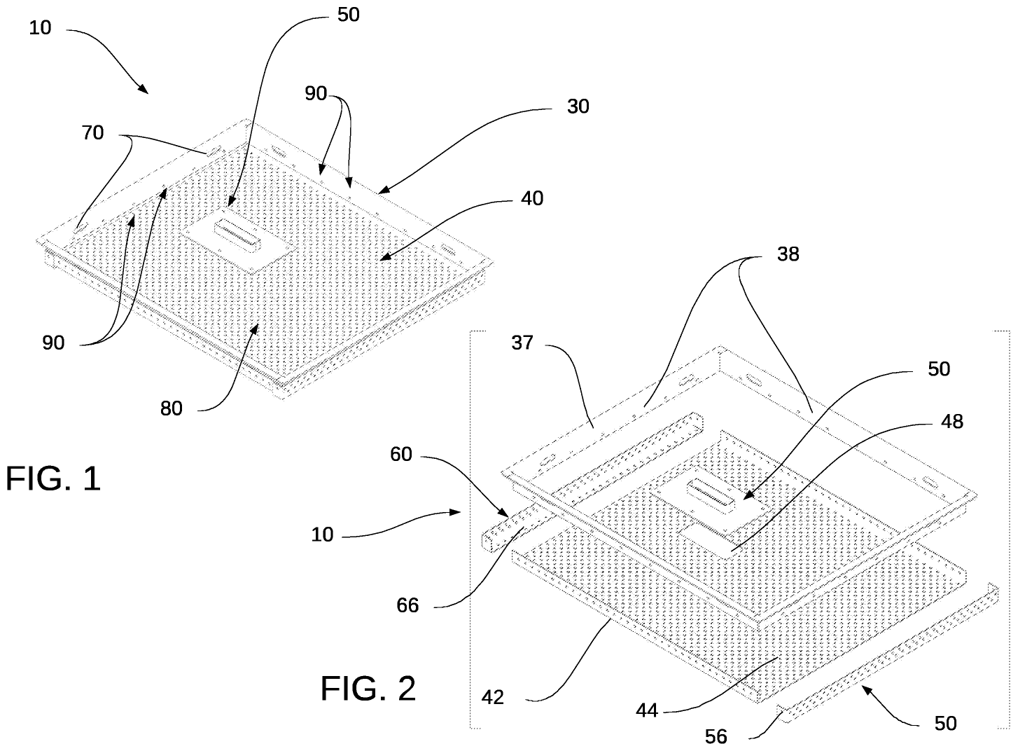

Referring to FIG. 1, a perspective top view of the precursor screen 10 according to the inventive subject matter is shown. The precursor screen 10 comprises a support frame 30 joined to a perforated tray 40. The perforated tray 40 includes a passthrough assembly 46 for the operation of a valve 20 (shown in later figures).

The perforated tray 40 comprises a center U-shaped base screen 42 preferably made from 14-gauge, 304 stainless steel and includes perforations 80 wherein the perforations 80 are sized to address specific filtering requirements. For example, in one instance the perforations 80 have a 5 mm diameter. As illustrated the perforations 80 cover approximately 40% of the area of the surface of the base screen 42. In another instance, the perforations 80 may be no more than 1 mm in diameter to address, for example, typical filtering requirements in plastic manufacturing facilities. Likewise, the end screens 50, 60 are fabricated from the same stainless steel material having the same perforation size and density distribution. Both the center U-shaped base screen 42 and the end screens 50, 60 may be fabricated from flat stainless steel stock which is perforated and then bent into the desired shape, and then assembled using rivets 90 through the perforations 80.

Now in greater detail and referring to FIG. 2, an exploded view of the precursor screen 10 of FIG. 1 is shown. The inventive subject matter preferably comprises a rectangular-shaped tray 40 made from perforated stainless steel material. The perforated tray 40, in one embodiment, comprises a U-shaped base screen 42 joined with two rectangular end screens 50, 60. The base screen 42 and end screens 50, 60 may have equivalent perforation density and spacing. The end screens 50, 60 include a U-shaped edge flange 56, 66 that creates a support in which the ends 46, 48 of the base screen 42 are placed for assembly using rivets 90 driven through aligned perforations 80.

In one embodiment, the perforations 80 are 3/16″ in diameter (slightly less than 5 mm) and accept appropriately sized rivets 90 for assembly. In other embodiments, the size of the perforations 80 may be changed to deal with other filtration requirements. For example, where plastic is involved with a facility, it is typical that the perforations 80 should be no larger than 1 mm in diameter. Other sized perforations 80 may be cut into the tray 40. During assembly, the end screens 50, 60 are adjustable such that a plurality of perforations 80 in the edge flanges 56, 66 are aligned with perforations 80 in the base screen 42. Rivets 90 are inserted in matching and aligned perforations 80 to fasten the end screens 50, 60 to the base screen 42 via the U-shaped edge flanges 56, 66.

The assembled perforated tray 40 is joined to the support frame 30 using rivets 90 through alignable perforations 80. A vertical perimeter leg 38 of the support frame 30 is joined to the base screen 42 and the end screens 50, 60 of the tray 40. The vertical leg 38 of the frame 30 fits and conforms to the shape of the tray 40. The rivet hole spacing in the perimeter vertical leg 38 is substantially correlated with the spacing of the perforations 80 in the base screen 42 and end screens 50, 60. The tray 40 is fastened to frame 30 using rivets 90. The perimeter vertical leg 38 of the frame 30 may include one or more weep holes 70 in the face of the vertical leg 38 to provide an option for the overflow of the stormwater runoff into the collection box 1 if the precursor screen 10 becomes filled with trash and debris. The weep holes 70 may be larger in size than the perforations 80. The support frame 30 further includes a lateral flange 37 that extends horizontally from the vertical leg 38 and circumscribes the frame 30 to serve as an attachment or support means for supporting the entire precursor screen 10 and any accumulated debris and entrained water within the collection box 1. A pass through assembly 46 is joined to the floor 44 of the base screen 42 at the location of a pass through port 48

Thusly configured, the inventive subject matter can be inexpensively manufactured and simply and easily installed and serviced before, during and after wet weather events. In another configuration, the perforated tray 40 may be adjusted during assembly to cover the weep holes 70, still using the same perforation arrangement. The entire precursor screen 10 is preferably fabricated from three pieces of flat perforated stainless steel, four angle brackets and a plurality of rivets 90.

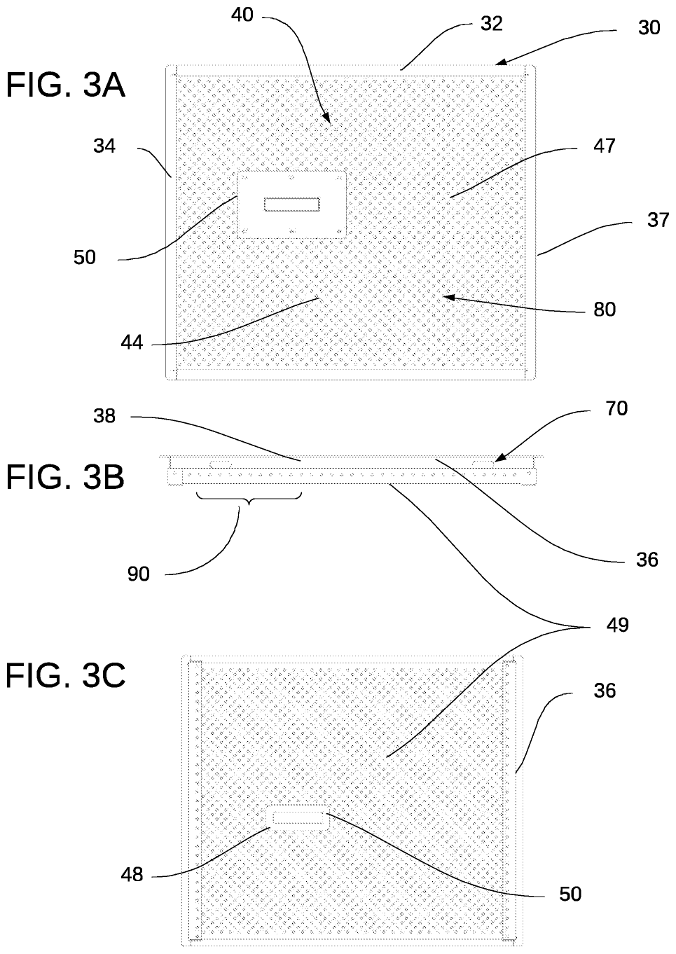

Referring now to FIG. 3A, a top plan view of the precursor screen 10 is shown, comprising the support frame 30, the perforated tray 40 and the pass-through assembly 50. Two end brackets 34 and two side brackets 32 are welded together to form the support frame 30. The floor 44 of the tray 40 is shown, wherein the entirety of the floor 44 has distributed perforations 80.

Referring now to FIG. 3B a side elevation view of the precursor screen 10 is shown. The perforated tray 40 is secured to the upper support frame 30 using rivets 90 placed through perforations 80 that align with rivet holes 92 within the vertical leg 38 of the support frame 30. The perforations 80 may be sized to address filtration requirements for a specific installation. For example, the perforations 80 may be 5 mm in diameter to comply with one regulatory requirement but no more than 1 mm in diameter to comply with another regulatory requirement. The size of the perforations 80 is modifiable to allow compliance with multiple regulatory or operational requirements. Weep holes 70 penetrate the vertical leg 38 of the support frame 30 above the top rim of the perforated tray 40. In an alternative configuration, the inventive subject matter provides manufacturing flexibility where the perforated tray 40 may be joined to the vertical leg 38 of the support frame 30 in closer proximity to an under bottom 36 of the lateral support frame 30. In this configuration, the perforated tray will cover the weep holes 70, eliminating overflow capacity. The perforated tray 40 is still attached using rivets 90 that pass through the next level of aligned perforations 80.

Referring now to FIG. 3C, a bottom plan view of the precursor screen 10 is shown. An under bottom 49 of the perforated tray 40 includes an access port 48 for receiving the pass-through assembly 50.

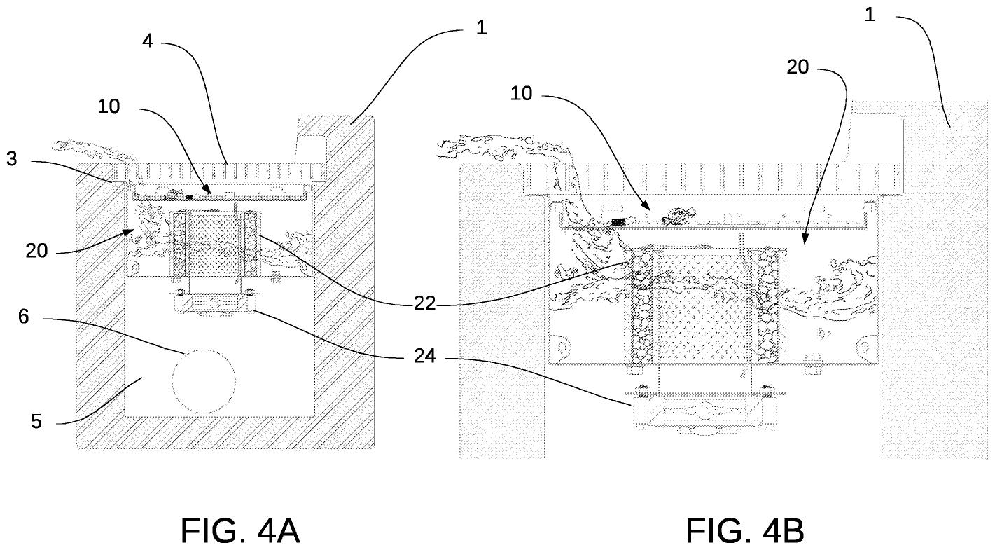

Referring now to FIG. 4A and FIG. 4B, the precursor screen 10 is shown with a valve 24 in a closed position to prevent fluid from passing into the sump 5 of the collection box 1. In one configuration, the precursor screen 10 is installed on and supported by the shoulders 3 of the collection box 1. The shoulders 3 can be pre-existing, or in another configuration, a separate support flange (not shown) may be installed within the interior of the collection box 1 (precast storm drain catchment) to support the precursor screen 10. Stormwater runoff and associated trash will pass through the storm drain grate 4 and onto the precursor screen 10. The precursor screen 10 includes perforated surfaces which allow liquids to pass through while capturing trash and debris. The filtrate of the storm water runoff will pass into a secondary basin 20 having a filtration apparatus 22 and valve 24. The valve 24 may be opened using a valve key 26 to rotate the valve stem 28. Once the valve 24 is opened, the filtrate, minus the debris captured in the precursor screen 10, will pass into the sump 5 of the collection box 1 and then flow through an outlet 6 to other portions of the storm drain network.

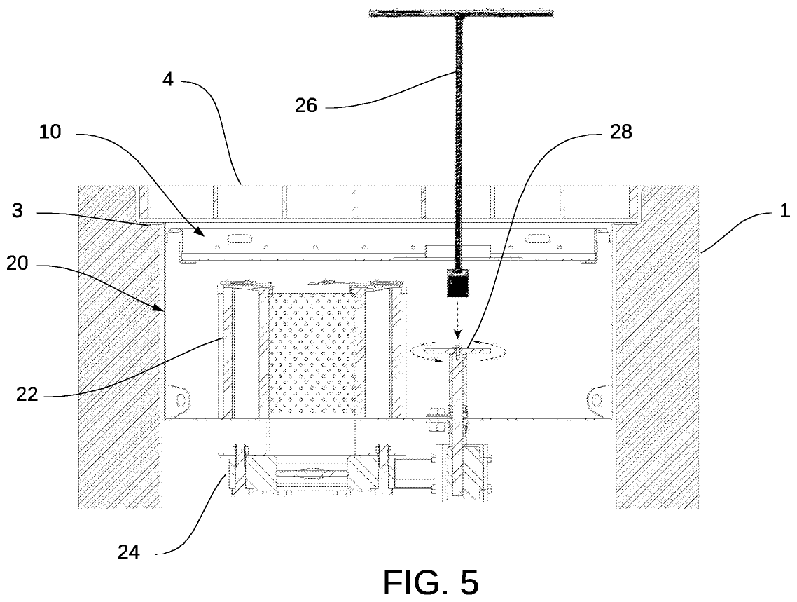

Referring now to FIG. 5, a cross-sectional view of the precursor screen installed according to the inventive subject matter is illustrated. The precursor screen 10 is shown installed in the mouth of the collection box 1 above the secondary basin 20. A valve key 26 includes a distal end sized to fit through an opening in said passthrough assembly 50 and shaped to engage a handle 28 on a valve stem of said valve 24 for opening and closing the valve 24. The valve key 26 includes a proximal end with an operating handle sufficiently sized to allow a single individual to open and close said valve through rotation. Different shapes and sizes of the tip and handle may be provided to adapt to different types of valves.

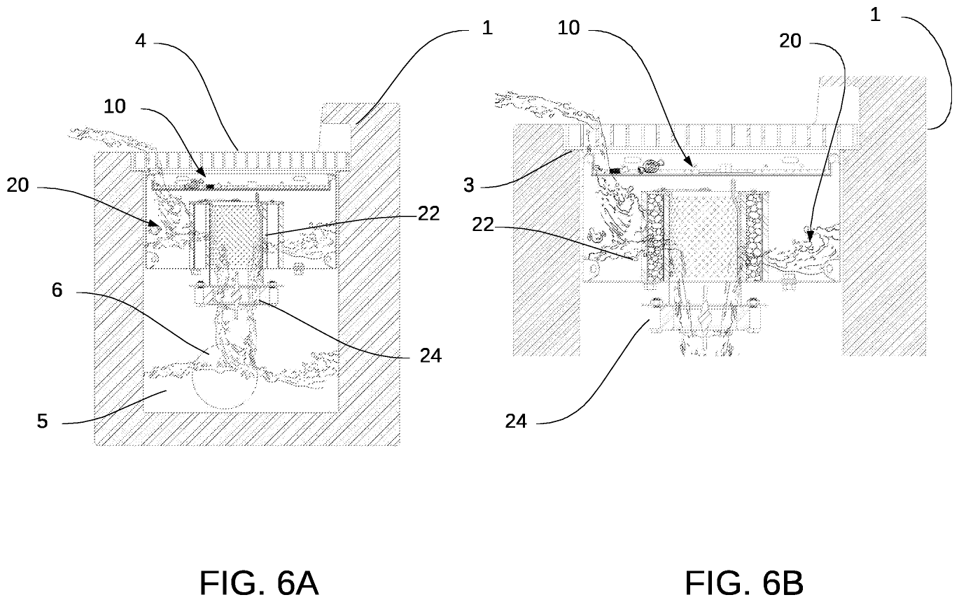

Referring now to FIG. 6A and FIG. 6B, the inventive subject matter comprises a precursor screen 10, shown here with the valve 24 in an open position to allow fluid to pass through the precursor screen 10, into the insert basin 20 and into the sump 5. In one configuration, the precursor screen 10 is installed on and supported by the shoulders 3 of the collection box 1. The shoulders 3 can be pre-existing, or in another configuration, a separate support flange (not shown) may be installed within the collection box 1 to support the precursor screen 10. Stormwater runoff and associated trash will pass through the storm drain grate 4 and onto the precursor screen 10. The precursor screen 10 includes perforated surfaces which allow liquids to pass through while separating and capturing trash and debris. The filtrate of the storm water runoff through the precursor screen 10 will pass into a secondary basin 20 having a filtration apparatus 22 and valve 24. With the valve opened, the filtrate will move into the sump 5 of the collection box 1 and then flow through an outlet 6 to other portions of the storm drain network.

It will be appreciated that although the embodiments described herein relate to a preferred embodiment for the precursor screen 10 according to the inventive subject matter of the disclosure, the precursor screen may be quickly fabricated to conform to any of a variety of different storm drain types.

For example, one skilled in the art would recognize that the primary components including the support frame 30 and the perforated tray 40 may be fabricated to fit within other differently shaped catch basins, including square, rectangular, circular and other such shapes. Still further, the present embodiment may be scaled to fit different sized storm drains. For example, in Seattle, Wash., there are a plethora of old small storm drains where the present precursor screen 10 could be modified to fit within and retrofitted to these older storm drain configurations.

Further, it is to be understood that the above-described embodiments are merely illustrative of numerous and varied other embodiments which may constitute applications of the principles of the inventive subject matter. Such other embodiments may be readily devised by those skilled in the art, with access to the present disclosure, without departing from the spirit or scope of this inventive subject matter and it is the inventor's intent that these other embodiments be deemed within the scope of the invention.

What is claimed is:

1. A surface drain precursor screen comprising:
a. a perforated tray;
b. said perforated tray joined to a frame and configured to rest on a support in a collection box.

2. The surface drain precursor screen of claim 1 wherein said perforated tray includes a passthrough assembly for receiving a distal end of a valve key to operate a valve positioned below said precursor screen.

3. The surface drain precursor screen of claim 1 wherein said valve is positioned above a secondary basin; said secondary basin collecting debris not captured by said surface drain precursor screen.

4. The surface drain precursor screen of claim 1 wherein said distal end of said valve key has a tip sized to fit through an opening in said passthrough assembly while still having sufficient size to engage a handle on a valve stem of said valve for opening and closing said valve; and, said valve key having a proximal end with an operating handle sufficiently sized to allow a single individual to open and close said valve via rotational force.

5. The precursor screen of claim 1 wherein said precursor screen is sized to fit within the inlet of a secondary basin positioned in a collection box.

6. The precursor screen of claim 1 wherein said perforated tray is joined to said frame using rivets.

7. A precursor screen having a perforated tray, said perforated tray comprising:
a. a base screen;
b. a first end screen;
c. a second end screen; and,
d. a support frame for positioning said precursor screen on a perimeter support of a secondary basin.

8. The precursor screen of claim 7 wherein said frame includes a plurality of rivet holes distributed about a perimeter leg of said frame, said rivet holes spaced and aligned to correlate with said perforations in said perforated tray for assembly using rivets.

9. The precursor screen of claim 7 wherein said perimeter support comprises two or more shoulders of a collection box.

10. The precursor screen of claim 7 wherein said perimeter support comprises an upper rim of a secondary basin.

11. The precursor screen of claim 1 wherein said perimeter support comprises one or more flanges anchored to the interior of a collection box.

12. The precursor screen of claim 7 wherein said perforated tray and said frame are made from stainless steel.

13. The precursor screen of claim 7 wherein said perforated tray has perforations less than 5 mm in size to prevent particles 5 mm or larger from passing through said perforations.

14. The precursor screen of claim 13 wherein said perforations are no more than 1 mm in diameter, thereby preventing the passage of particles 1 mm or larger through said perforations.

15. A precursor screen for separating larger debris from smaller debris to improve performance of downstream filtration devices, comprising:
a. a perforated tray;
b. said perforated tray positioned above a secondary basin;
c. said secondary basin being sealed but for pores within a filtration device;
d. said filtration device positioned within said secondary basin and providing further filtration of stormwater runoff for discharge into the collection box and stormwater network.

16. The precursor screen of claim 15 wherein said perforated tray includes a pass-through assembly for operating a closure for a valve positioned adjacent a floor of said secondary basin.

17. The precursor screen of claim 16 wherein said pores of said filtration device are smaller than the perforations to provide two stages of filtration.

18. The precursor screen of claim 17 wherein said filtration device includes two or more filtration layers to capture smaller particles and remove one or more contaminants in the runoff.

19. The precursor screen of claim 15 wherein said perforated tray is combined with said secondary basin for unitary installation in the collection box.

20. The precursor screen of claim 19 wherein said precursor screen may be easily dismantled and removed from said secondary basin thereby supporting simpler disposal of captured trash in said perforated tray.
